(19) United States
(12) Patent Application Publication
(10) Pub. No.: US 2008/0116191 A1
(43) Pub. Date: May 22, 2008

(54) HEATED MIRROR SYSTEM FOR MOTOR VEHICLE

(76) Inventors: Eric Michael Rene Allen, Burlington (CA); Frenciscus Petrus Maria Mercx, Bergen op Zoom (NL); Matthew D. Marks, Waterford, MI (US)

Correspondence Address: SABIC - 08CT;SABIC Innovative Plastics - IP Legal, ONE PLASTICS AVENUE, PITTSFIELD, MA, 01201-3697, US

(21) Appl. No.: 11/561,522

(22) Filed: Nov. 20, 2006

(51) Int. Cl. H05B 3/20; B29C 65/70; B29C 45/14

(52) U.S. Cl. 219/219; 264/104; 264/105

(57) ABSTRACT

A heated mirror system for use in motor vehicles that includes the use of a thermally regulating material that eliminates electrical heater elements used in conventional heated mirror systems. The heated mirror system includes a mirror housing constructed from an electro thermally-active thermoplastic material. The electro thermally-active thermoplastic material is selected to be self-regulating such that the material heats up until it reaches a selected temperature at which point the resistivity of the material prevents further heating of the mirror housing to reduce the risk of damage to the mirror. The mirror is located in thermal contact in the mirror housing such that, as the electro thermally-active thermoplastic material heats, at least a portion of the heat is capable of heating the mirror. The mirror housing may be constructed using an injection molding process.

### FIELD OF INVENTION

The present invention relates to motor vehicles and, in particular, to heated mirror units utilized in motor vehicles.

### BACKGROUND OF INVENTION

Mirror units used on the exterior of motor vehicles can be prone to fogging or frosting, especially in colder climates. The result of the fogging or frosting is a mirror that is unusable by the driver of the motor vehicle, thereby creating a potential road hazard if the driver is unable to use the external mirrors. Accordingly, it would be beneficial to include a mechanism for removing fog and frost from external mirrors.

Prior art solutions have been proposed wherein the external mirror is provided with self-regulating electrical resistance heaters composed of positive temperature coefficient (PTC) materials. The PTC heaters are, in some embodiments, mounted on a metal or other suitable material (plastic, etc.) plate in a recess formed in the plate and a glass reflecting member is mounted on the plate over the recess for enclosing the heater in the recess. In this embodiment, the heater is enclosed in the mirror unit and is connected to electrical circuit for defogging the mirror.

However, these mirrors do not provide uniform heating to all portions of the mirror unit. As a result, these mirrors provide less than complete mirror defogging particularly in ambient temperature conditions and/or when the PTC heating element is operating in its stabilized, self-regulated, low heat output heating mode. On the other hand, if the PTC heating element includes too high of an operating temperature, there is a risk of damaging or breaking the glass in the mirror due to the development of hot spots in the mirror.

In another prior art embodiment, the heated mirror system may include a glass plate that includes a PTC resistive element that is fixed to the reflective layer of the mirror. However, the heat generation in these mirrors is oftentimes not uniform and it is sometimes necessary to supply higher amounts of electrical power than desired to the PTC resistive element to produce the gradual heating of the entire volume of glass.

In addition, many current heated mirror systems involve complicated assemblies that require many parts, including an electrical heater element. The cost of these prior art mirror assembly can be economically restrictive to basic vehicles such that heated mirror systems are generally only found on more expensive vehicles.

Accordingly, it would be beneficial to provide a heated mirror system for use in motor vehicles that provides more consistent heating of the glass while reducing the risk of damaging the glass due to excess amounts of electrical power and/or too high an operating temperature. It would also be beneficial to provide a heated mirror system for use in motor vehicles that is less expensive than prior art assemblies, thereby enabling the safety advantages of heated mirror systems to be more readily available.

### SUMMARY OF THE INVENTION

The present invention provides a heated mirror system for use on motor vehicles. The heated mirror system includes a mirror housing constructed from an electro thermally active thermoplastic material. The electro thermally-active thermoplastic material is designed such that when an electric current is supplied to the electro thermally-active thermoplastic material, the material heats up until it reaches a selected temperature at which point the resistivity of the electro thermally-active thermoplastic material prevents further heating of the housing to prevent the housing from becoming too hot such that the mirror housing may damage the mirror housed by the housing. The mirror is located in thermal contact in the mirror housing such that, as the electro thermally active thermoplastic material heats, at least a portion of the heat is capable of heating the mirror.

Accordingly, in one aspect, a heated mirror system is provided. The heated mirror system includes a molded mirror housing, at least two electrodes in electrical contact with the mirror housing for supplying electric current to the mirror housing, and at least one mirror pane disposed within the mirror housing; wherein the mirror housing comprises an electro thermally-active thermoplastic material and wherein the mirror pane is in thermal contact with the mirror housing. The electro thermally active thermoplastic material may include a thermoplastic polymer and at least one conductive filler.

In another aspect, a method of making a heated mirror system is provided. The method includes the steps of forming a molded mirror housing comprising an electro thermally-active thermoplastic material, integrating at least two electrodes in electrical contact with the mirror housing for supplying electric current to the mirror housing, and placing a mirror pane in thermal contact with the mirror housing. The electro thermally active thermoplastic material may include a thermoplastic polymer and at least one conductive filler.

### BRIEF DESCRIPTION OF THE DRAWING

FIG. 1 is a perspective view of a heated mirror system according to one embodiment of the present invention.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.” Furthermore, all ranges disclosed herein are inclusive of the endpoints and are independently combinable.

As used herein, approximating language may be applied to modify any quantitative representation that may vary without resulting in a change in the basic function to which it is related. Accordingly, a value modified by a term or terms, such as “about” and “substantially,” may not to be limited to the precise value specified, in some cases. In at least some instances, the approximating language may correspond to the precision of an instrument for measuring the value.

The present invention provides a heated mirror system for use on motor vehicles that eliminates the problems associated with prior art motor vehicle mirrors. The heated mirror system includes a mirror housing including an electro thermally active thermoplastic material. The electro thermally-active thermoplastic material is a positive temperature coefficient material that heats up until it reaches a selected temperature at which point the heater turns off thereby preventing further heating of the mirror housing which reduces the risk that heat from the mirror housing will damage the mirror housed by the mirror housing. The mirror is located in thermal contact in the mirror housing. As used herein, the term “thermal contact” refers to a mirror and mirror housing that are in such proximity to one another such that, as the electro thermally-active thermoplastic material in the mirror housing begins to heat, at least a portion of the heat is capable of heating the mirror, thereby enabling fog, frost and/or snow to be removed from at least a portion of the mirror surface. And by utilizing a positive temperature coefficient material, the heated mirror system is self-regulating such that no separate temperature sensors or control system is needed to regulate the temperature of the mirror housing and, therefore, the heated mirror system.

Accordingly, in a first aspect, the heated mirror systems of the present invention include a mirror housing utilizing a positive temperature coefficient (PTC) material. The PTC material is selected from any PTC material capable of being used in an external environment. Positive temperature coefficient (PTC) materials are materials that exhibit variable electrical resistance with temperature. As the temperature of the material increases, the electrical resistance also increases. The resistivity of the material increases so current flow is reduced, limiting heat flow. The PTC materials used in the present invention are designed to have a lower trip temperature as compared to prior art materials. As used herein, the “trip temperature” is the temperature that results in a substantial increase in the resistivity of the material. Prior to the trip temperature, the resistivity of the polymeric material does not change very much with a change in temperature. After the trip temperature, however, there is an increase of several orders of magnitude in the resistivity with temperature. In one embodiment, the PTC materials have a trip temperature less than 120° C. In another embodiment, the PTC materials have a trip temperature less than 90° C. In still another embodiment, the PTC materials have a trip temperature less than 70° C.

By utilizing a PTC material, the resulting heated mirror system becomes self-regulating. As such, the need for any temperature sensor and/or temperature control system, which are required in several prior art heaters, is eliminated. As such the heated mirror systems of the present invention are less complex, easier to use and/or permit greater control in designing applications utilizing these heated mirror systems.

In addition, the heated mirror systems of the present invention are, in one embodiment, designed such that the PTC material is located throughout the mirror housing. As such, substantially uniform heating of the article to be heated, such as a side mirror or rear-view mirror, can be achieved as compared to prior art heated mirror systems wherein localized heating often occurs. This can be especially beneficial for those applications, such as heated mirror systems, wherein substantially uniform heating of the article is desired.

In one embodiment, the PTC material used in the present invention is a self-regulating PTC material that includes any PTC material capable of having a preselected trip temperature designed into the PTC material. As such, the self-regulating PTC materials used in the present invention are designed such that the trip temperature is selected and the PTC material will trip at or near the trip temperature substantially all of the time, thereby making the PTC material self-regulating. Therefore, unlike prior art heated mirror systems that utilize temperature sensors and controllers to regulate the temperature of a heated article, the need for these sensors and controllers is eliminated, although it is to be understood that, in alternative embodiments, these sensors and/or controllers may be included.

Examples of self-regulating PTC materials that may be used in the present invention include, in one embodiment, materials constructed from at least one thermoplastic polymer and at least one conductive filler. The thermoplastic polymer may be selected from polyolefins, polyamides, polyesters, polycarbonates, polyimides, polyethylene, polypropylene, polyvinyl chloride, polyvinyl acetate, polyvinyl acetyl, acrylic resin, polystyrene, nylon, poly-tetra-fluorethylene, polybutylene-terephthalate, polyphenylene-sulfide, polyamideimide, polyimide, ethyl-vinyl alcohol, poly(methyl methacrylate), high-density polyethylene, linear low-density polyethylene, low-density polyethylene, mid-density polyethylene, polyisobutylene, poly(vinylidene chloride), poly(vinylidene fluoride), poly(methylacrylate), polyacrylonitrile, polybutadiene, polyethylene-terephthalate, poly(8-aminocaprylic acid), poly(vinyl alcohol), ethylene-based copolymers, maleic anhydride grafted polyethylene, glycidyl methacrylate grafted polyethylene, maleic acid anhydride, glycidyl methacrylate grafted polypropylene, and blends, mixtures, or combinations of one or more of the foregoing thermoplastic polymers. The conductive filler may be selected from carbon black; graphite; conductive carbon black; metal powders; metal oxides; ceramics; minerals; stabilizers; lubricants; or a combination of one or more of the foregoing conductive fillers.

The self-regulating PTC materials may include any combination of materials and/or amounts of materials that enable the resulting self-regulating PTC material to have a preselected trip temperature designed into the PTC material. The exact amount of thermoplastic material and/or type of conductive filler will vary depending on or more factors including, but not limited to, the article in which the PTC material is used, the selected trip temperature, the shape of the heated article and/or the PTC material. In one embodiment, the self-regulating material includes from 5 to 80 wt.% of the thermoplastic polymer and from 95 to 20 wt. % of at least one conductive filler.

As discussed, the PTC material is located throughout the mirror housing. In one embodiment, the mirror housing is constructed entirely from the PTC material. In this embodiment, the mirror housing may be formed using any method capable of forming a mirror housing from a thermoplastic-based material. Examples of methods that may be used in the present invention include, but are not limited to, extrusion molding, blow molding, compression molding, injection molding, compression-injection molding, melt molding (such as co-extrusion molding), T-die extrusion, inflation extrusion, profile extrusion, extrusion coating and multi-layer injection molding or a combination including one of the foregoing methods.

In an alternative embodiment, the PTC material is located in a portion of the mirror housing. In this embodiment, the mirror housing may include a multi-layer substrate wherein the layer closest to the mirror is constructed from the PTC material while the layer located further from the mirror is constructed from a non-PTC material, such as a plastic material. In an alternative embodiment, the layer further from the mirror is constructed from the PTC material while the layer located closer to the mirror is constructed from a non-PTC material. Examples of thermoplastic polymers that may be used in the present invention include, but are not limited to, polyethylene (PE), including high-density polyethylene (HDPE), linear low-density polyethylene LLDPE, low-density polyethylene (LDPE), mid-density polyethylene (MDPE), maleic anhydride functionalized polyethylene, maleic anhydride functionalized elastomeric ethylene copolymers, ethylene-butene copolymers, ethylene-octenene copolymers, ethylene-acrylate copolymers like ethylene-methyl acrylate, ethyelene-ethyl acrylate and ethtylene butyl acrylate copolymers, glycidyl methacrylate modified polyethylene, polypropylene (PP), maleic anhydride functionalized polypropylene, glycidyl methacrylate modified polypropylene, polyvinyl chloride (PVC), polyvinyl acetate, polyvinyl acetyl, acrylic resin, syndiotactic polystyrene (sPS), polyamides, including but not limited to PA6, PA66, PA11, PA12, PA6T, PA9T, poly-tetra-fluorethylene (PTFE), polybutylene-terephthalate (PBT), polyphenylene-sulfide (PPS), polyamideimide, polyimide, Polyethylene vinyl acetate (EVA), glycidyl methacrylate modified polyethylene vinyl acetate, Polyvinylalcohol, poly(methyl methacrylate) (PMMA), polyisobutylene, poly(vinylidene chloride), poly(vinylidene fluoride) (PVDF), poly(methylacrylate), polyacrylonitrile, polybutadiene, polyethylene-terephthalate (PET), poly(8-aminocaprylic acid), poly(vinyl alcohol) (PVA), polycaprolactone, or blends, mixtures or combinations of one or more of these polymers.

When the electro thermally-active thermoplastic material is used to form at least a part of the mirror housing, the electro thermally-active thermoplastic material housing includes at least two electrodes placed in electrical contact with the mirror housing such that electrical current is capable of being applied to the mirror housing. The electrodes may be placed on an exterior surface of the mirror housing or may be molded into the mirror housing using any known method for integrating electrodes with a mirror housing. The electrodes may include an electrode path for distributing electric current throughout the mirror housing. The electrode path is integrated with the electrodes and the mirror housing to enable uniform or substantially uniform electric current to be distributed throughout the mirror housing.

The electrodes may be in the form of wires, plates, rods, or the like. The electrodes may be constructed of metal including, but not limited to, copper, silver, lead, or zinc. In alternative embodiment, the electrodes may also be made of a nonmetal substance, such as carbon. The electrodes may include connections for a wire harness, such as blades or tips. The electrodes may include an electrode path that is simply a portion of the electrodes themselves. In an alternative embodiment, the electrode path may be a separate material capable of carrying electric current from the electrodes to the mirror housing. Accordingly, the electrode path may include wires or rods distributed along or within the mirror housing in electrical contact with the mirror housing. Conversely, in an alternative embodiment, the electrode path may include a conductive ink, such as a silver ink, that is distributed along the mirror housing in electrical contact with the mirror housing and the electrodes.

In use, current is applied to the electrodes that then distribute the current to the mirror housing, either alone or in conjunction with the electrode path. The heated mirror system is designed such that electric current is supplied in a uniform or substantially uniform manner to the thermoplastic mirror housing material. The thermoplastic mirror housing material then heats up to a specified temperature. As described, the electro thermally-active thermoplastic material is a PTC material that trips at a selected temperature to result in a heated mirror system that is self-regulating and that reduces the risk of damage to the mirror glass due to excessive heating. In one embodiment, the mirror housing also includes molded in attachments and/or ribs providing strength and stiffness to support the mirror glass.

The foregoing and other features of the present invention will be more readily apparent from the following detailed description and drawings of the illustrative embodiments of the invention wherein like reference numbers refer to similar elements.

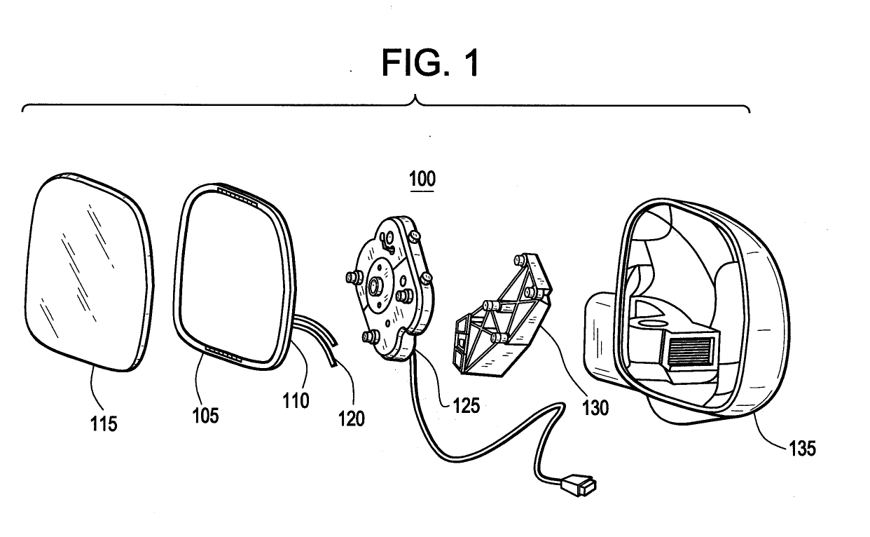

FIG. 1 provides one embodiment of a heated mirror system according to the present invention. The heated mirror system 100 includes a mirror housing 105 constructed from an electro thermally active thermoplastic material. In this embodiment, injection molding is used to form the mirror housing 105. During formation, an electrical terminal 110 is inserted into the mirror housing 105 injection mold. The mold is then injected with an electro thermally-active thermoplastic material to produce the mirror housing 105. Electrodes are then incorporated into the housing. A glass mirror 115 is then mounted (such as by press fitting, or the use of adhesive, etc.) into the housing mirror 105 to make up the heated mirror system 100. Electrical wires 120 are then attached to the mirror housing 105, and the unit is then fit together with the other mirror components including a motor 125, a bracket 130 and the outer shell 135 to provide a finished heated mirror system 100. In an alternative embodiment, instead of insert molding the terminals 110, they can also be applied after molding.

The concepts of the present invention may be utilized in conjunction with any type of side or rearview mirror in a motor vehicle. Since the mirror and mirror housing are in thermal contact with one another, there may be additional components of the mirror included such as motors, brackets, out shells and the like. Since most rear and side view mirrors are contained within outer shells, the wires for the electrode can easily be hidden and may receive power in the same manner as power for any motor for operating the mirror electronically.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. A heated mirror system comprising:
a molded mirror housing;
at least two electrodes in electrical contact with the mirror housing for supplying electric current to the mirror housing; and
at least one mirror pane disposed within the mirror housing;
wherein the mirror housing comprises an electro thermally-active thermoplastic material;
wherein the mirror pane is in thermal contact with the mirror housing.

2. The heated mirror system of claim 1, wherein the electro thermally-active thermoplastic material comprises a thermoplastic polymer and a conductive filler.

3. The heated mirror system of claim 2, wherein the thermoplastic polymer is selected from polyolefins, polyamides, polyesters, polycarbonates, polyimides, polyethylene, polypropylene, polyvinyl chloride, polyvinyl acetate, polyvinyl acetyl, acrylic resin, polystyrene, nylon, poly-tetra-fluorethylene, polybutylene-terephthalate, polyphenylene-sulfide, polyamideimide, polyimide, ethyl-vinyl alcohol, poly(methyl methacrylate), high-density polyethylene, linear low-density polyethylene, low-density polyethylene, mid-density polyethylene, polyisobutylene, poly(vinylidene chloride), poly(vinylidene fluoride), poly(methylacrylate), polyacrylonitrile, polybutadiene, polyethylene-terephthalate, poly(8-aminocaprylic acid), poly(vinyl alcohol), ethylene-based copolymers, maleic anhydride grafted polyethylene, glycidyl methacrylate grafted polyethylene, maleic acid anhydride, glycidyl methacrylate grafted polypropylene, and blends, mixtures, or a combination of one or more of the foregoing thermoplastic polymers.

4. The heated mirror system of claim 2, wherein the conductive filler is selected from carbon black; graphite; conductive carbon black; metal powders; metal oxides; ceramics; minerals; stabilizers; lubricants; or a combination of one or more of the foregoing fillers.

5. The heated mirror system of claim 1, wherein the mirror housing further comprises a second layer comprising a thermoplastic material.

6. The heated mirror of claim 5, wherein the thermoplastic material is selected from acrylonitrile-butadiene-styrene (ABS), polycarbonate, polycarbonate/ABS blend, a copolycarbonate-polyester, acrylic-styrene-acrylonitrile (ASA), acrylonitrile-(ethylene-polypropylene diamine modified)-styrene (AES), phenylene ether resins, glass filled blends of polyphenylene oxide and polystyrene, blends of polyphenylene ether/polyamide, blends of polycarbonate/PET/PBT, polybutylene terephthalate and impact modifier, polyamides, phenylene sulfide resins, polyvinyl chloride PVC, high impact polystyrene (HIPS), low/high density polyethylene, polypropylene and thermoplastic olefins (TPO), polyethylene and fiber composites, polypropylene and fiber composites, or a combination thereof.

7. The heated mirror of claim 1, wherein at least one electrode comprises a path of conductive silver ink.

8. A method of forming a heated mirror system assembly comprising the steps of:
forming a molded mirror housing comprising an electro thermally-active thermoplastic material;
integrating at least two electrodes in electrical contact with the mirror housing for supplying electric current to the mirror housing; and
placing a mirror pane in thermal contact with the mirror housing.

9. The method of claim 8, wherein the electro thermally-active thermoplastic material comprises a thermoplastic polymer and a conductive filler.

10. The method of claim 9, wherein the thermoplastic polymer is selected from polyolefins, polyamides, polyesters, polycarbonates, polyimides, polyethylene, polypropylene, polyvinyl chloride, polyvinyl acetate, polyvinyl acetyl, acrylic resin, polystyrene, nylon, poly-tetra-fluorethylene, polybutylene-terephthalate, polyphenylene-sulfide, polyamideimide, polyimide, ethyl-vinyl alcohol, poly(methyl methacrylate), high-density polyethylene, linear low-density polyethylene, low-density polyethylene, mid-density polyethylene, polyisobutylene, poly(vinylidene chloride), poly(vinylidene fluoride), poly(methylacrylate), polyacrylonitrile, polybutadiene, polyethylene-terephthalate, poly(8-aminocaprylic acid), poly(vinyl alcohol), ethylene-based copolymers, maleic anhydride grafted polyethylene, glycidyl methacrylate grafted polyethylene, maleic acid anhydride, glycidyl methacrylate grafted polypropylene, and blends, mixtures, or a combination of one or more of the foregoing thermoplastic polymers.

11. The method of claim 9, wherein the conductive filler is selected from carbon black; graphite; conductive carbon black; metal powders; metal oxides; ceramics; minerals; stabilizers; lubricants; or a combination of one or more of the foregoing fillers.

12. The method of claim 8, wherein the mirror housing further comprises a second layer comprising a thermoplastic material.

13. The method of claim 12, wherein the thermoplastic material is selected from acrylonitrile-butadiene-styrene (ABS), polycarbonate, polycarbonate/ABS blend, a copolycarbonate-polyester, acrylic-styrene-acrylonitrile (ASA), acrylonitrile-(ethylene-polypropylene diamine modified)-styrene (AES), phenylene ether resins, glass filled blends of polyphenylene oxide and polystyrene, blends of polyphenylene ether/polyamide, blends of polycarbonate/PET/PBT, polybutylene terephthalate and impact modifier, polyamides, phenylene sulfide resins, polyvinyl chloride PVC, high impact polystyrene (HIPS), low/high density polyethylene, polypropylene and thermoplastic olefins (TPO), polyethylene and fiber composites, polypropylene and fiber composites, or a combination thereof.

14. The method of claim 8, wherein the mirror housing is molded using a molding process selected from extrusion molding, blow molding, a compression molding, injection molding, compression-injection molding, melt molding (such as co-extrusion molding), T-die extrusion, inflation extrusion, profile extrusion, extrusion coating and multi-layer injection molding or a combination including one of the foregoing methods.

15. The method of claim 14, wherein the mirror housing is molded using an injection molding process.

16. The method of claim 8, wherein at least one electrode comprises a path of conductive silver ink.
